(19) United States
(12) Patent Application Publication
(10) Pub. No.: US 2014/0278904 A1
(43) Pub. Date: Sep. 18, 2014

(54) INTERACTION WITH PRIMARY AND SECOND SCREEN CONTENT

(71) Applicants: Joshua Seiden, Centennial, CO (US); Derek Johnson, Philadelphia, PA (US)

(72) Inventors: Joshua Seiden, Centennial, CO (US); Derek Johnson, Philadelphia, PA (US)

(73) Assignee: Comcast Cable Communications, LLC, Philadelphia, PA (US)

(21) Appl. No.: 13/827,921

(22) Filed: Mar. 14, 2013

(51) Int. Cl. G06Q 30/02

(52) U.S. Cl. CPC G06Q 30/0207
USPC 705/14.36; 705/14.1

(57) ABSTRACT

Methods and systems for processing primary and secondary content, and providing rewards are disclosed. In one embodiment, a content server provides primary and second screen content to a user on one or more computing devices. A content server may process the primary and second screen content to identify whether a user is eligible for a reward based on the user's previous experiences, such as interactive experiences, with the content.

### BACKGROUND

Today, users have the option of using a computing device, such as a tablet computer, to view a webpage related to content they are experiencing or otherwise consuming. Such pages are useful for keeping users engaged in a particular program. Users also may want the ability to access additional information or content on a second device. Thus, an improved system and method for interacting with primary and second screen content is desired.

### SUMMARY

The following presents a simplified summary of the present disclosure in order to provide a basic understanding of some aspects described herein. This summary is not an extensive overview, and it is not intended to identify key or critical elements or to delineate the scope of the claims. The following summary merely presents various described aspects in a simplified form as a prelude to the more detailed description provided below.

According to one aspect of the disclosure, a recognition, status change, acknowledgement, or reward may be provided to a user in response to the user's interaction with primary and/or second screen content. In particular, content is transmitted from a content server to a first screen device or second screen device associated with a user. Content may also be transmitted from a data processing facility, such as a local office, to the user. After the content is transmitted and displayed (or presented) on a device associated with the user, the content server receives an indication that the content has been experienced, or otherwise consumed, by the user. Thereafter the content is processed to identify the existence of a second screen event. This may be done by determining whether the content server contains or has access to a corresponding segment of content (e.g., a corresponding fingerprint) that matches one or more characteristics of the content that has been transmitted to a device associated with the user. The identification of the second screen event may occur while a user experiences or otherwise consumes the content.

If a second screen event is identified, a determination may be made concerning whether the second screen event is valid. In some instances, the user of the first screen and/or second screen device may have the option of accessing additional content. This content may be associated with the information content of the second screen event. For example, a second screen event relating to a sporting event may be identified while the user is experiencing, or otherwise consuming the content. Subsequently, additional content may be transmitted to the second screen device, such as scores to other recent sporting events, related applications, a link to a website selling tickets to a sporting event, a link to a website offering sports-themed music, or advertising content that relates to sports, etc.

Another determination may be made regarding whether the user is eligible to receive the reward. If a valid second screen event is identified, a reward is generated in accordance with the valid second screen event. In some instances, one or more generated rewards are tailored or customized in accordance with the information content of the second screen event. A unique identifier may be assigned to the generated reward, thus permitting each reward to be individually identified and traced. Once a reward has been generated and assigned a unique identifier, the content server may identify a device or application that has requested the reward, and then transmit the response to a device associated with the user. For example, the content server may identify that a mobile device associated with a particular user has requested a reward. In other examples, the content server may identify a software application associated with a user has requested a reward. In some instances, users may have the option of interacting with the reward and/or the content that has been transmitted.

In another aspect of the disclosure, an apparatus includes a processor, and a memory having stored therein computer executable instructions, that when executed by the processor cause the apparatus to perform a method of providing a reward to a user in response to the user's interaction with primary and/or second screen content. The apparatus receives content from a content server and transmits that content to the user's first screen and/or second screen device. In some instances, an apparatus may receive the content from a data processing facility. After the content is transmitted, the apparatus receives an indication that the user has experienced or otherwise consumed the content. During the display or presentation of the content to the user, the apparatus may receive an identification of a second screen event associated with the content that the user is experiencing. Subsequently, the apparatus also receives an indication of whether the second screen event is valid. Thereafter, in the event of a valid second screen event, the apparatus may request that a reward be transmitted to a device associated with the user. In some instances, the apparatus may be equipped with an input device or a sensor capable of receiving a request from the user's first screen and/or second screen device to display or present the reward to the user.

Other details and features will also be described in the sections that follow. This summary is not intended to identify critical or essential features of the inventions claimed herein, but instead merely summarizes certain features and variations thereof.

### BRIEF DESCRIPTION OF THE DRAWINGS

Some features herein are illustrated by way of example, and not by way of limitation, in the figures of the accompanying drawings and in which like reference numerals refer to similar elements.

FIG. 1 illustrates an example communication network on which various features described herein may be used.

FIG. 2 illustrates an example computing device and software configuration that can be used to implement any of the methods, servers, entities, and computing devices described herein.

FIG. 3 illustrates system architecture according to one or more illustrative aspects described herein.

FIG. 4 illustrates an example embodiment of the disclosure.

FIG. 5 illustrates an example embodiment of disclosure.

FIG. 6 is a diagram illustrating an example method according to one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

By way of introduction, the various features described herein may allow a user to consume primary content (e.g., watch a television program) on a first screen device (e.g., a television) and second screen content, which may be synchronized with the primary content, on a second screen device (e.g., a smartphone, tablet, laptop, etc.). In one example, a content device (e.g., a gateway) associated with the first screen device may receive an indication that the primary content has been delivered to the user, and may process the primary content to identify and report a second screen event detected within the primary content. After the second screen event is detected, a content server may determine whether the event is valid. If a valid second screen event occurs, the content server generates a reward, or similar recognition, status change, or acknowledgement in accordance with the second screen event. This reward may be created based on the information content of the second screen event, which can include, but is not limited to data relating to the primary content and data received from a service provider or other administrator relating to the primary content. The system may assign a unique identifier to one or more generated rewards, with the identifier uniquely identifying each reward transmitted to the second screen device.

FIG. 1 illustrates an example communication network 100 on which many of the various features described herein, such as the requesting and retrieval of primary content and second screen content may be implemented. Network 100 may be any type of information distribution network, such as satellite, telephone, cellular, wireless, etc. One example may be an optical fiber network, a coaxial cable network, or a hybrid fiber/coax (“HFC”) distribution network. Such networks 100 use a series of interconnected communication links 101 (e.g., coaxial cables, optical fibers, wireless, etc.) to connect multiple premises 102 (e.g., businesses, homes, consumer dwellings, etc.) to a local office, headend, or data processing facility 103. The local office 103 may transmit downstream information signals onto the links 101, and each premises 102 may have a receiver used to receive and process those signals.

There may be one link 101 originating from the data processing facility, such as local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths. By running fiber optic cable along some portions, for example, signal degradation may be significantly minimized, allowing a single local office 103 (e.g., a data processing facility, etc.) to reach even farther with its network of links 101 than before.

The local office 103 may include a content device, such as a termination system (TS) 104. In an example embodiment of an HFC network, the content device 104 may be a cable modem termination system (CMTS), which may be a computing device configured to manage communications between devices on the network of links 101 and backend devices such as servers 105-107 (to be discussed further below). The content device 104 may be as specified in a standard, such as the Data Over Cable Service Content device Specification (DOCSIS) standard, published by Cable Television Laboratories, Inc. (a.k.a. CableLabs), or it may be a similar or modified device instead. The content device 104 may be configured to place data on one or more downstream frequencies to be received by modems at the various premises 102, and to receive upstream communications from those modems on one or more upstream frequencies.

The local office 103 (e.g., a data processing facility, etc.) may also include one or more network content devices 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the network content device 108 may include the corresponding circuitry needed to communicate on the external networks 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various premises 102 in the network (or more specifically, to the devices in the premises 102 that are configured to detect such notifications). The local office 103 may also include a content server 106. The content server 106 may be one or more computing devices that are configured to provide content to users at their premises. This content may be, for example, video on demand movies, television programs, songs, text listings, etc. The content server 106 may include software to validate user identities and entitlements, to locate and retrieve requested content, to encrypt the content, and to initiate delivery (e.g., streaming or transmitting) of the content to the requesting user(s) and/or device(s).

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing and listening habits and collecting that information for use in selecting advertisements. Yet another application server may be responsible for formatting and inserting advertisements in a video or audio stream being transmitted to the premises 102. Although shown separately, one of ordinary skill in the art will appreciate that the push server 105, content server 106, and application server 107 may be combined. Further, here the push server 105, content server 106, and application server 107 are shown generally, and it will be understood that they may each contain memory storing computer executable instructions to cause a processor to perform steps described herein and/or memory for storing data, such as information for identifying a user or second screen device.

An example premise 102a, such as a home, may include a content device 120, which can comprise any data processing and/or presentation device. The content device 120 can include any communication circuitry needed to allow a device to communicate on one or more links 101 with other devices in the network. For example, the content device 120 may include a modem 110, which may include transmitters and receivers used to communicate on the links 101 and with the local office 103 (e.g., a data processing facility, etc.). The modem 110 may be, for example, a coaxial cable modem (for coaxial cable lines 101), a fiber content device node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the content device 120. Further, the content device 120 may include a gateway 111. The modem 110 may be connected to, or be a part of, the gateway 111. The gateway 111 may be a computing device that communicates with the modem(s) 110 to allow one or more other devices in the premises 102a, to communicate with the local office 103 and other devices beyond the local office 103. The gateway 111 may be a set-top box (STB), digital video recorder (DVR), computer server, or any other desired computing device. The gateway 111 may also include (not shown) local network content devices to provide communication signals to requesting entities/devices in the premises 102a, such as first screen devices 112 (e.g., televisions), additional STBs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), and any other desired devices. Examples of the local network content devices include Multimedia Over Coax Alliance (MoCA) content devices, Ethernet content devices, universal serial bus (USB) content devices, wireless content devices (e.g., IEEE 802.11, IEEE 802.16), analog twisted pair content devices, Bluetooth content devices, and others.

FIG. 2 illustrates general hardware elements that can be used to implement any of the various computing devices discussed herein. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired storage medium. Instructions may also be stored in an attached (or internal) hard drive 205. The computing device 200 may include one or more output devices, such as a display 206 (e.g., an external television), and may include one or more output device controllers 207, such as a video processor. There may also be one or more user input devices 208, such as a remote control, keyboard, mouse, touch screen, microphone, etc. The computing device 200 may also include one or more network content devices, such as a network input/output (I/O) circuit 209 (e.g., a network card) to communicate with an external network 210. The network input/output circuit 209 may be a wired content device, wireless content device, or a combination of the two. In some embodiments, the network input/output circuit 209 may include a modem (e.g., a cable modem), and the external network 210 may include the communication links 101 discussed above, the external network 109, an in-home network, a provider's wireless, coaxial, fiber, or hybrid fiber/coaxial distribution system (e.g., a DOCSIS network), or any other desired network.

FIG. 2 shows an example computing device and software configuration that can be used to implement any of the methods, servers, entities, and computing devices described herein. Modifications may be made to add, remove, combine, divide, etc. components of the computing device 200 as desired. Additionally, the components illustrated may be implemented using basic computing devices and components, and the same components (e.g., processor 201, ROM storage 202, display 206, etc.) may be used to implement any of the other computing devices and components described herein. For example, the various components herein may be implemented using computing devices having components such as a processor executing computer-executable instructions stored on a computer-readable medium, as illustrated in FIG. 2. Some or all of the entities described herein may be software based, and may co-exist in a common physical platform (e.g., a requesting entity can be a separate software process and program from a dependent entity, both of which may be executed as software on a common computing device).

Additionally, the computing device 200 may include a synchronization manager 201a, which can perform the various methods for realizing synchronization of the second screen content with the primary content described herein as a replacement for, or augment to, any other processor 201 that the computing device 200 may include. That is, the synchronization manager 201a may include a separate processor and/or set of computer-executable instructions stored on a computer-readable medium that, when executed by a processor, cause the processor (or the computing device 200 as a whole) to perform the various methods of the present disclosure, such as processing detection signals, monitoring detection signals, generating statistical information and multipliers, and generating synchronization signals. The synchronization manager 201a may also include secure memory (not shown), which can store the various statistical information, multipliers, algorithms, and zone information described herein. The secure memory can be any desired type of memory, and can have enhanced security features to help restrict access (e.g., can only be accessed by the synchronization manager 201a, can be internal to the synchronization manager 201a, etc.). Where the synchronization manager 201a includes a separate set of computer-executable instructions, these instructions may be secured such that only authorized users may be allowed to modify, augment, or delete them.

In some embodiments, the synchronization manager 201a may be implemented as an application specific integrated circuit (ASIC). That is, the synchronization manager 201a may be a chip designed specifically for performing the various processes described herein. Further, the ASIC may be implemented within or in communication with various computing devices provided herein.

One or more aspects of the disclosure may be embodied in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

FIG. 3 is a diagram showing an exemplary system architecture 300 on which various features described herein may be performed. The system 300 of FIG. 3 depicts a local office 103 (e.g., a data processing facility, etc.), a first premises 102a, a second premises 102b, one or more content distribution networks (CDN) 310 and 320, a network 330, and a second screen experience server 340. As shown in FIG. 1, the local office 103 may connect to the first premises 102a and second premises 102b via links 101. The first premises 102a may include a content device 120 (e.g., a gateway), a first screen device 301 (e.g., a television, a monitor, a laptop, a projector, etc.), and one or more second screen devices 302 (e.g., a smartphone, tablet, laptop, etc.). As shown, in FIG. 3, multiple users A and B may be located at the first premises 102a and each user may operate a second screen device 302 while consuming content via the first screen device 301. Meanwhile, the second premises 102b may include a content device 120, a first screen device 301, and a second screen device 302 used by a user C. Content may be transmitted from the local office 103 to the content devices 120 of the first and second premises 102a-b, and streamed through to the first screen devices 301. Thus, users A and B may consume content (e.g., view or listen to the content) at the premises 102a and user C may consume content at the premises 102b. Notably, while consuming content, each user may operate a respective second screen device 302 to consume second screen content related to the primary content streamed on the first screen device 301 at their premises 102. For example, user A may operate a second screen device 302, such as a smartphone, to consume second screen content, such as a poll through which user A may vote for a contestant shown in the primary content streamed through the first screen device 301. The second screen content may be any data that provides information or content to supplement primary content, which is the content (e.g., linear television program, on-demand movie, audio content etc.) streamed on a first screen device 301. For example, second screen content may include a link to a webpage of a product shown in an advertisement of the primary content, a video clip with bonus features, text and/or images with information about the content itself or about individuals or items shown in the primary content, advertisements, coupons, questions pertaining to the primary content, etc. The various second screen content may be generated from ordinary everyday consumers of the primary content, as well as from formal primary content sources.

Referring to FIG. 3, users may consume content at a premise 102a (e.g., a home, business, etc.). Consuming content may include, for example, watching and/or listening to a television program or internet video on a first screen device 301 (e.g., a television, computer monitor, projector, etc.). The first screen device 301 may receive the content from the content device 120, which is connected to a data processing facility, such as local office 103, and configured to retrieve the primary content. FIG. 3 also illustrates some examples of second screen devices 302, namely a smartphone and a laptop computer. Each second screen application may be configured to download and execute a second screen experience application through which a user may select and consume second screen content. The second screen application may require a user to enter in credentials (e.g., username and password) during an account registration or authorization process. Although FIG. 3 shows some example second screen devices 302, many other devices may be used as second screen devices 302. Indeed, even another television, similar in configuration to a first screen device 301, may be used as the second screen device 302. The second screen device 302 may also be a specially designed device (e.g., an enhanced television remote) for specific use in the embodiments disclosed herein.

Further, each of the second screen devices 302 may be configured to bi-directionally communicate via a wired and/or wireless connection with the second screen experience server 340 via the network 330. The second screen experience server 340 may store or have access to second screen content experienced or otherwise consumed by the user, including external content libraries, etc. The second screen devices 302 may be configured to access the network 330 (e.g., the Internet) to obtain second screen content and to transmit/receive signals via the network 330 to/from the second screen experience server 340. For example, a second screen device 302 may transmit detection signals through a wired connection, including the links 101 through which the content is supplied to a first screen device 301, to the local office 103 (e.g., a data processing facility, etc.), which then routes the transmission to the network 330 so that it may eventually reach the second screen experience server 340. That is, the second screen device 302 may connect to the content device 120 and communicate with the second screen experience server 340 over-the-top of the links 101 used to transmit the primary content downstream. Alternatively, a second screen device 302 may wirelessly communicate via, for example, a WiFi connection and/or cellular backhaul, to connect to the network 330 (e.g., the Internet) and ultimately to the second screen experience server 340. Accordingly, although not shown, the network 330 may include cell towers and/or wireless routers for communicating with the second screen devices 302.

Although FIG. 3 depicts the second screen experience server 340 as being separate from the local office 103, in some embodiments, the second screen experience server 340 may be located at the local office 103. In such embodiments, the second screen devices 302 may still access the second screen experience server 340 through the network 330. Further, even though the second screen experience server 340 is shown as a single element, in some embodiments, it may include a number of computing devices 200, which may include the synchronization manager 201a.

Still referring to FIG. 3, the local office 103 may include a router 305, a second screen experience management platform 306 for executing any of the steps described herein, and a database 307 for storing user information (e.g., user profiles), primary content, second screen content, and/or computer-executable instructions for inserting triggers, transmitting multipliers, or any of the steps described herein. The router 305 of the local office 103 may forward requests for content from users and/or user devices (e.g., first screen device 112) at premises 102 to one or more CDNs 310 and 320 that may supply the requested content. The local office may also include device 308 for facilitating network communications in accordance with the steps described herein.

Each of the CDNs 310 and 320 may include one or more routers 311 and 321, whose purpose is to receive requests from users (e.g., via their local offices) and route them to servers within its network that may store the requested content and be able to supply it in response to the request. A CDN 310 for a given piece of content might have a hierarchy of one primary source, and a plurality of lower-level servers that can store (e.g., cache) the content and respond to requests. The lower-level servers that ultimately service the request may be referred to as edge servers, such as one or more edge servers 312 and 322. The various servers may include one or more content databases 313 and 323, which store content that the respective CDN 310 and 320 manages. In some embodiments, the CDNs 310 and 320 may provide the same or similar content. In other embodiments, the CDNs 310 and 320 may offer different content from one another. Also, the CDNs 310 and 320 may be maintained/operated by the same or different content providers. Although only two CDNs 310 and 320 are shown, many CDNs may be included in the system architecture 300 of FIG. 3.

FIG. 4 is a diagram illustrating an aspect of the present disclosure. FIG. 4 illustrates that a network, such as a service provider network including a plurality of content devices 120 located at various premises 102, may be separated into a plurality of zones (e.g., Zone 1, Zone 2, Zone 3, etc.). Each zone may include a plurality of content devices 120 (e.g., gateways). The amount of content devices 120 in each zone and/or the geographical region covered by each zone may be different. In some examples, the zones may correspond to zip codes or area codes. In other examples, each zone may include multiple zip codes or area codes. Vice versa, multiple zones may make up a single zip code or area code. One of skill in the art will recognize that in another aspect of the invention, various methods may be used to group content devices using criteria other than zones. For example, geographical information, demographic information, or other information associated with the user may be used to group content devices.

Regardless of how the content devices are split up into different zones, an aspect of the present disclosure is that each zone may receive the same primary content including identical secondary content (e.g., advertisements). In other words, the local office 103 may deliver the same primary content to each of the content devices 120 in the same zone so that users of the content devices 120 are exposed to the same secondary content. Content devices 120 in different zones may receive different content. In particular, the advertisements delivered to the content devices 120 of different zones may be different. For example, all of the content devices 120 in Zone 1 may receive a television program with an advertisement for a car during a commercial break, while all of the content devices 120 in Zone 2 may receive the same television program but the advertisement at the same commercial break may be for a clothing store. In this example, the television program is the same, but the television programs may also be different. Among the different zones there may be differences with respect to the channel (e.g., television channel) the content is delivered on or the time at which the content is delivered.

It should be understood that content devices 120 in different zones may also receive the same primary content including the same advertisements, however this might not always be the case. Further, while the content delivered to each of the content devices 120 in the same zone may be the same, it should be understood that the precise time at which the content arrives at the content devices 120 in the same zone may be different. For example, there may be delays in transmitting the content such that one content device in Zone 1 receives the content at a first time, whereas another content device in Zone 1 receives the same content at a second time a few seconds later.

FIG. 5 is a diagram showing a system architecture 500 illustrating, which is another aspect of the present disclosure. The system 500 may include a number of premises 102a, 102b, a local office 103, a network 530, a supplemental content server 541, and a synchronization manager 542. At each of the premises 102 there may be a content device 120a, 120b, a first screen device 301a, 301b, and a second screen device 302a, 302b. As shown in FIG. 5, the premises 102a and 102b may belong to the same zone Z. However, in other embodiments, the premises 102a and 102b may belong to different zones, or be associated with different groups. As shown in FIG. 5, although content devices 120a and 120b may belong to the same zone, the content devices are capable of receiving different primary content C1 and C2. Herein, primary content C1 and primary content C2 may refer to the content shown on first screen devices 301a and 301b, and may include, for example, television programs, advertising commercials, or music content. It should be understood that primary content C1 and primary content C2 may be transmitted and displayed (or presented) at second screen devices 302a and 302b, respectively. It should also be understood that primary content C1 and primary content C2 may include similar content, but may be different in terms of their advertisements. For example, primary content C1 and primary content C2 may include the same television program at the same time on the same television channel, but have different advertisements during the commercial breaks.

As shown in FIG. 5, different primary content C1 and C2 can be transmitted to content devices 120a and 120b. However, this is just one example scenario intended to illustrate that two content devices (e.g., 120a and 120b) within the same zone Z may receive different content at the same time. Likewise, it is also understood that two content devices (e.g., 120a and 120b) within the same zone Z may receive the same content at the same time (e.g., if they are tuned to the same channel). In other words, each content device 120 may transmit whatever particular piece of content is desired from among the entire collection of primary content C1 or C2 that it receives. In some embodiments, the content device may receive interactive content, allowing a user to interact with the content as it is consumed (e.g., during the user's viewing or listening experience). For example, a user may have the option of identifying that they enjoy the content being experienced, or otherwise consumed. In another example, a user may have the option of receiving additional content by performing predetermined tasks associated with the display or presentation of the interactive content.

In some embodiments, content devices 120 may transmit a detection signal back upstream after detecting that primary content has been received by the user. For example, FIG. 5 shows that content device 120a may transmit a detection signal back upstream after detecting that primary content C1 has been received. This detection signal D1 serves as an indication that the primary content has been received at first screen device 301a located at premises 102a. Similarly, at premises 102b, content device 120b may transmit a first detection signal D3 back upstream after detecting that primary content C2 has been received. This first detection signal also serves as an indication that primary content C2 has been received at first screen device 301b. In one embodiment, the first detection signal may not be sent by content devices 120 until a sufficient amount of content has been received at the first screen device or consumed by the user. In another embodiment, the first detection signal may be sent once the initial transmission of primary content to first screen devices 301.

In another embodiment, the second screen device 302 may transmit a first detection signal (not shown) back upstream after detecting that primary content C1, C2 has been received at the second screen device 302. In some embodiments, the second screen device 302 may transmit a first detection signal (not shown) back upstream after detecting that primary content C1, C2 has been captured at second screen devices 302. In one embodiment, the second screen device may be equipped with a software application that enables a microphone, video camera, or other recording device of the second screen device to begin capturing the primary content displayed or presented on the first screen device. In some embodiments, the second screen device 302 may transmit the first detection signal, or other signals to content device 120.

In other embodiments, content device 120 may be configured with a sensor, or another sensing or input device, to receive signals transmitted from second screen devices 302. Content device 120 may be configured to receive a request from the second screen device to control operation of viewing or listening functions. For example, a user may operate the second screen device 302, via an application, for example, in a similar manner as a remote control associated with content device 120 so as to change the primary content currently being experienced, or otherwise consumed at first screen device 301. In other examples, the second screen device 302 may adopt each of the control functions of a standard remote control associated with content device 120 (e.g., play, pause, stop, fast-forward, rewind, record, etc.).

Still referring to FIG. 5, first detection signal D1 indicating whether primary content C1 has been received, may be transmitted to a supplemental content server 541, which may store or have access to supplemental content for a second screen experience. Supplemental content server 541 may be configured to receive first detection signal D1 from content device 120a and generate and transmit a return signal R1 to begin processing primary content C1 when identifying a second screen event. In one example, content device 120a may begin processing primary content C1 once first detection signal D1 is transmitted to supplemental content server 541.

In one embodiment, once content device 120 receives an indication that the primary content has been received, content device 120 may process the primary content to identify a second screen event. In other embodiments, an application server 107 (not shown) may process primary content C1 to identify a second screen event. In yet another embodiment, second screen device 302 may process primary content C1 to identify a second screen event. For example, a user, via a software application on a second screen device 302, may direct second screen device 302 to capture and process primary content being displayed or presented at first screen device 301 in order to identify a second screen event. In still other examples, supplemental content server 541 may be configured to transmit a request for an identification of the second screen event. This request may be sent to one or more computing devices, including content devices 120, application server 107 (not shown), or second screen devices 302.

In one aspect, the second screen event may signal the supplemental content server 541 that second screen content associated with the primary content is available. In some embodiments, primary content C1, C2 may include triggers embedded within the content to assist in identifying the second screen event. These triggers may contain or have access to information identifying the subject matter of the primary content. In one embodiment, primary content C2 may have different triggers than primary content C1. For example, even where primary content C1 and primary content C2 are similar (e.g., where C1 and C2 both include the same television show), primary content C1 may have different commercials than primary content C2, and therefore, the triggers in the different commercials may be different. In another embodiment, primary content C1 and C2 are the same, and thus have the same triggers. For example, primary content C1 delivered to content device 102a may include the same triggers as primary content C2 delivered to content device 102b.

In one embodiment, the triggers may be embedded by content creators (not shown) at the time primary content C1, C2 is created. In another embodiment, the triggers may be embedded by local office 103 (e.g., a data processing facility, etc.) before delivering the primary content to the appropriate content devices. In some embodiments, the triggers used to identify the second screen event may be embedded within primary content C1, C2 at constant or variable intervals. In one embodiment, primary content C1, C2 may include a different trigger every five minutes. In another embodiment, primary content C1, C2 may include a different trigger based on the particular content being shown. For example, a different trigger may be placed at the beginning and end of each commercial.

In another example, different triggers may be placed throughout a television program. In yet another embodiment, the triggers may include information identifying the associated primary content C1, C2 or other information, such as information for supplementing primary content C1, C2. In still another embodiment, the triggers may include a unique or random identifier that allows each trigger, and subsequently each second screen event, to be identified by supplemental content server 541. Various formats for the triggers may be used. In one embodiment, the trigger format may be the Enhanced TV Binary Interchange Format (EBIF).

In some embodiments, content device 120 processes primary content captured between a first trigger and a second trigger during the display or presentation of the primary content. In one embodiment, content device 120 determines whether the supplemental content server 541 may contain or have access to a corresponding segment of primary content (e.g., a corresponding fingerprint) that matches the display or presentation of primary content captured between the first and second triggers. This may be accomplished by comparing the primary content captured between the first and second triggers with the corresponding fingerprint stored at the supplemental content server 541. It should be understood that other embodiments may be utilized by a service provider to determine whether a content server may contain or have access to a corresponding fingerprint that matches the primary content captured at a computing device, without departing from the scope of the present disclosure. In another embodiment, application server 107 determines whether the second supplemental server 541 may contain or have access to a corresponding fingerprint associated with the display or presentation of the primary content captured between the first and second triggers.

Still referring to FIG. 5, content device 120a sends a second detection signal D2 to supplemental content server 541 indicating that a second screen event has been identified. It should be understood that application server 107 may also send a second detection signal to supplemental content server 541 indicating that a second screen event has been identified. In some embodiments, second detection signal D2 may contain information identifying the subject matter of the second screen event obtained from triggers utilized to identify the second detection event. In one embodiment, supplemental content server 541 may analyze second detection signal D2 associated with a particular second screen event in order to identify the information content of the second screen event. For example, where the second detection signal is sent in response to a trigger embedded in an advertisement for a car, supplemental server 541 may analyze the signal and identify that the information content of the second screen event is generally directed to subject matter relating to cars. As a result, supplemental content server 541 may utilize this information to generate a reward, recognition, status change, or other acknowledgement that generally relates to the subject matter of cars.

In still other embodiments, the second detection signal may include a unique or random identifier that may allow supplemental content server 541 to identify a second screen event. In some embodiments, the second detection signal may include information associated with the user, including user demographic information (e.g., age, zip code, time zone, marital status), which may be provided by the user in response to a request from the content provider. In one embodiment, user information may be stored in a database located at the supplemental content server 541. In another embodiment, user information may be stored at content device 120. In other embodiments, user information obtained by a service provider may be stored in external databases accessible by supplemental content server 541. It should be understood that other embodiments may be utilized by a service provider to obtain user information without departing from the scope of the present disclosure. In other embodiments, content devices 120 may transmit a message to supplemental content server 541, using network 530, to provide the identification of the second screen event. It should also be understood that content devices 120 may use other methods to communicate the identification of a second screen event to supplemental content server 541.

Still referring to FIG. 5, second detection signals D2, D4 may be also transmitted to synchronization manager 542. Synchronization manager 542 may be configured to receive the second detection signal, and generate and transmit synchronization signals S1, S2 to second screen devices 302. In some embodiments, synchronization manager 542 may identify and analyze the second detection signal to determine what triggers and/or other information are associated with the second detection signal. Synchronization manager 542 may then generate a specific synchronization signal S1, S2 based on this determination so that second screen devices 302 can synchronize second screen content (“SSC”) with the primary content. For example, where the second detection signal is sent in response to a trigger embedded in an advertisement for a car, synchronization manager 542 may generate and transmit a synchronization signal S1 to second screen devices 302a and 302b indicating that content devices 120a and 120b have recently transmitted a car advertisement to a device associated with the user. As a result, second screen devices 302a and 302b may synchronize second screen content to display or present a portion of the second screen content related to the car in synchronization with the primary content which recently included the advertisement for the car. Synchronization signal S1 may be a multicast signal sent to a plurality of second screen devices 302 listening for multicast signals. The second screen devices 302 may then determine whether the synchronization signal S1 is related to the second screen content it is transmitting. Alternatively, the synchronization signal S1 may include a plurality of signals that are selectively pushed to particular second screen devices 302 that have identified themselves as transmitting related second screen content. Synchronization signal S2 may be transmitted by the same synchronization manager 542 that transmits synchronization signal S1. The synchronization manager 542 may transmit synchronization signal S2 in response to a different detection signal D4, than detection signal D2, which may be transmitted to the synchronization manager 542 by content device 120a
Further, FIG. 5 further illustrates the paths of transmission of second screen content (“SSC”). Supplemental content server 541 may be configured to transmit SSC to one or more of second screen devices 302 via network 530, which may include a cellular backhaul, the Internet, and/or additional local and wide area networks. The SSC may be multicast or unicast to the second screen devices 302. In some embodiments, second screen devices 302 may first transmit a request (not shown) to supplemental content server 541 for specific SSC. For example, when a user via an application on a second screen device 302 directs the second screen device 302 to transmit specific second screen content, second screen device 302 may send a request identifying the second screen content desired to supplemental content server 541. In response to this request, supplemental content server 541 may transmit SSC back to second screen device 302. It is understood that the request for second screen content may simply refer to the primary content for which second screen content is desired and supplemental content server 541 may detect what second screen content to respond with.

As shown in FIG. 5, the same second screen content may be sent to different second screen devices 302a and 302b associated with different content devices 102a and 102b. Once a second screen device 302 receives SSC and a synchronization signal S1, S2, second screen device 302 may perform synchronization. Specifically, the second screen device 302 may use synchronization signals S1, S2 to determine which segment or time point in the SSC to transmit. As a result, second screen content transmitted to the second screen device may be synchronized with the primary content on the associated first screen device 301. This synchronization is illustrated by the dashed lines connecting second screen devices 302 with their associated first screen devices 301. Furthermore, while FIG. 5 shows second screen content and the synchronization signals as different signals, in some embodiments they may be the same.

Still referring to FIG. 5, the second detection signal sent by content devices 120 may include information allowing supplemental content server 541 to identify a second screen event. In other embodiments, the second detection signal may include a unique or random identifier that may allow supplemental content server 541 to identify the second screen event. It is understood that content device 120 may use other methods to communicate the identification of a second screen event to supplemental content server 541. For example, in some embodiments, content device 120 may transmit a message to supplemental content server 541, using network 530, to provide the identification of the second screen event.

Once the second screen event is identified, supplemental content server 541 may determine whether the second screen event is valid, (e.g., whether the user may be eligible for a reward). The reward may comprise a variety of different types or formats, such as credits, awards, coupons, discounts, status changes, acknowledgements, advancements, etc., that are assigned to a user based on their viewing or listening history. Additionally, the reward may comprise enhanced viewing or listening capabilities assigned to a user during future interaction with the content. For example, a user may be awarded the ability to skip future advertisements contained in primary content and secondary content. In another example, a user may be awarded the ability to skip a block of advertisements contained in video on demand content offered by the content provider. A user may also be rewarded for experiencing or otherwise consuming primary content and/or secondary content containing an advertising commercial. A user may also receive a reward for viewing or listening to the entirety or a substantial portion of a commercial on either first screen device 301 or second screen device 302. Alternatively, the user may be required to exceed a threshold number of commercials viewed or heard before receiving a reward. It is to be understood that other embodiments may be utilized to implement this reward system, such a points-based reward system, and functional modifications may be made to the reward system, without departing from the scope of the present disclosure.

In one embodiment, supplemental content server 541 may determine that a user is not eligible to receive a reward if the user has previously received a second screen event identical to the identified second screen event within a predetermined time period. For example, a user may not receive a reward after experiencing the same commercial multiple times within a predetermined time period. In another embodiment, supplemental content server 541 may determine that a user is not eligible to receive a reward if the user has previously received a reward associated with the identified second screen event. In yet another embodiment, supplemental content server 541 may determine that a user is not eligible to receive a reward if the user has exceeded a threshold number of rewards within a predetermined time period. In still another embodiment, supplemental content server 541 may determine whether a user is not eligible to receive a reward by analyzing a user's account information or credentials. For example, a user may not receive a reward if parental authorization is required for that particular user account. It is to be understood that other embodiments may be utilized to determine whether a user may be eligible to receive a reward, and functional modifications may be made, without departing from the scope of the present disclosure.

The supplemental content server may generate a reward, recognition, status change, or acknowledgement in accordance with the second screen event. This is accomplished by processing the information content and/or trigger associated with the validated second screen event to determine a particular reward to transmit to a device associated with the user. For example, a commercial for a live sporting event may contain a trigger or information content relating to sports. Accordingly, this information may be processed by supplemental content server to determine a reward that is generally related to the field of sports. Example rewards may include a coupon for sports apparel or equipment, a discount on tickets to a live sporting event, a discount on the cost of a sports pay-per-view event provided by the content provider, and so forth.

In one embodiment, supplemental content server 541 may processes user information, including user demographic information and/or previous viewing or listening history, when selecting one or more rewards for transmission. In other embodiments, supplemental content server 541 may acquire user information, including user demographic information and/or previous viewing or listening history, when selecting one or more rewards for transmission. In some instances, the supplemental content server may have access to external databases containing user information. In another embodiment, supplemental content server 541 analyzes the information content of the second screen event to generate one or more rewards. Supplemental content server 541 may assign a unique or random identifier to the reward that allows supplemental content server 541 to subsequently identify the reward after the response has been generated. The unique identifier assigned to the reward may be recorded by the supplemental content server and stored in a user database. This unique identifier may be associated with user information, including user demographic information, stored at the supplemental content server 541.

The user database may be used by the content provider to track user viewing and listening history or purchase habits. For example, a user experiencing a sporting event may receive a coupon for athletic apparel as a reward. This reward, e.g., the coupon, may be assigned a unique identifier, which is subsequently stored and associated with user in the user database. If the coupon is redeemed, the user database may record information relating to the user's subsequent purchase, such as the date and time of the purchase. Utilizing this information and other generated analytics, such as whether a user has experienced or skipped particular advertising content or the average latency in redeeming a reward, an advertiser may analyze the user's viewing history and purchase habits. After a reward has been generated and assigned a unique or random identifier, supplemental content server 541 may transmit the reward to second screen devices 302. In one embodiment, supplemental content server 541 may transmit the reward to first screen devices 301. In some embodiments, supplemental content server 541 may receive a request for the display or presentation of the reward. In other embodiments, local office 103 may receive a request for the display or presentation of the reward. The reward can be transmitted to the user through a variety of different methods. For example, the reward can be transmitted as an electronic mail message to a personal account established by the user. In another example, the reward can be transmitted over network 330 to a plurality computing devices associated with the user, including one or more first screen devices 301 or second screen devices 302. In some examples, the reward can be transmitted to a user's reward account established by the content provider. In one example, the reward may be transmitted to an application on second screen device 302 that may be associated with the user's reward account. In another example, the reward may be transmitted to an application on first screen device 301 that may be associated with the user's reward account. In still another example, supplemental content server 541 may determine whether a user may be eligible for a reward by analyzing the user's reward account.

Still referring to FIG. 5, second screen devices 302 may transmit a request to supplemental content server 541 for the reward, recognition, status change, acknowledgement, etc. In one example, when a user via an application on a second screen device 302 directs a second screen device 302 to transmit specific primary content or second screen content, the second screen device 302 may send a request identifying the primary content or second screen content desired to supplemental content server 541. In response to this request, supplemental content server 541 may determine whether the user has previously accrued a reward, and may transmit a reward to second screen device 302 for display or presentation to the user.

In yet another example, a user via an application on second screen device 302 may direct the second screen device to request additional content in accordance with the information content of a second screen event. In response to this request, supplemental content server 541 may transmit additional content to second screen device 302 relating to the subject matter of a second screen event identified as the user experiences or otherwise consumes content. For example, if a second screen event relating to football is identified during the user's viewing and listening experience, supplemental content server 541 may transmit additional content to second screen device 302, such as scores to recent football games, a link to a website selling tickets to football games, or advertising content that relates to football. In some embodiments, a user operating the second screen device 302 may interact with the reward that has been sent to the second screen device. In one embodiment, the reward may contain a link to a website where users may redeem or utilize the particular reward. In another embodiment, the reward may direct a user to a website that provides additional content relating to the information content of the second screen event used to generate the reward. In yet another embodiment, the display or presentation of the reward may provide the user with access to interactive content.

In other embodiments, the supplemental content server may be configured to identify the user application requesting the reward. In one embodiment the source application resides on first screen device 301 or second screen device 302. In another embodiment the source application resides on content device 120. In still another embodiment, the user application may transmit information relating to the device hosting the application, as well as other user information. In still other embodiments, second screen devices 302 may transmit a request to supplemental content server 541 for second screen content. In some embodiments the request for second screen content may simply refer to the primary content for which second screen content is desired and supplemental content server 541 may detect what second screen content to respond with. As shown in FIG. 5, the same second screen content may be sent to different second screen devices 302a and 302b associated with different content devices 102a and 102b.

FIG. 6 is a flow diagram illustrating an example method according to one or more aspects of the disclosure. In one aspect, the method may provide a reward at a second screen device based on their interaction with primary and/or second screen content.

In step 601, supplemental content server 541 may transmit primary content to a first screen device. In one embodiment, primary content C1 and primary content C2 may refer to the content shown on first screen devices 301, and may include, for example, both television programs and advertising commercials. In another embodiment, local office 103 (e.g., a data processing facility, etc.) may transmit primary content to a first screen device. During step 601, second supplemental server 541 may also transmit primary content C1, C2 to second screen devices for display or presentation to the user.

In step 602, supplemental content server 541 may receive an identification of a second screen event. In some embodiments, content device 120 processes the primary content to identify the second screen event, and content device 120 transmits a second detection signal to supplemental content server 541 indicating that a second screen event has been identified. In other embodiments, application server 107 may process the primary content to identify the second screen event, and application server 107 transmits a second detection signal to supplemental content server 541 indicating that a second screen event has been identified. In other embodiments, primary content may include triggers embedded within the content to assist in identifying the second screen event. In still another embodiment, the supplemental content server 541 may be configured to request an identification of the second screen event. In another embodiment, content device 120 determines whether supplemental content server 541 may contain or have access to a corresponding fingerprint associated with the display or presentation of the primary content.

In step 603, the supplemental content server determines whether the second screen event identified in step 602 is valid. In some embodiments, the supplemental content server 541 may determine whether the user has exceeded a threshold number of rewards within a predetermined time period. In another embodiment, the supplemental content server 541 may determine whether the user has previously received a reward associated with the identified second screen event. In other embodiments, the local office 103 determines whether the second screen event identified in step 602 is valid.

In step 604, the supplemental content server generates a reward in accordance with the second screen event. In one embodiment, supplemental content server 541 may generate a reward by processing information content associated with the second screen event. In another embodiment, supplemental content 541 server may generate a reward by processing the triggers associated with the second screen event. In yet another embodiment, local office 103 (e.g., a data processing facility, etc.) generates a reward in accordance with the second screen event. In other embodiments, supplemental content 541 server may generate a reward by processing user information obtained by the service provider. In some embodiments, the supplemental content server 541 may be configured to identify a source application requesting the determined reward. In one embodiment, the source application resides on first screen device 301 or second screen device 302. In another embodiment, the source application resides on content device 120. In still another embodiment, supplemental content server 541 analyzes the information content of the second screen event to generate one or more rewards.

In step 605, the supplemental content server assigns a unique identifier to the reward generated in step 604. In some embodiments, the unique identifier assigned to the reward may be recorded and stored in a user database. In one embodiment, the user database may be utilized to subsequently monitor a user's viewing and listening history or purchase habits. In other embodiments, local office 103 assigns a unique identifier to the reward generated in step 604.

In step 606, the supplemental content server transmits the reward to the user. In one embodiment, the reward may be transmitted by supplemental content server 541 as an electronic mail message to the user's e-mail account. In another embodiment, the reward may be transmitted by supplemental content server 541 to a plurality of computing devices associated with the user, such as first screen device 301 or second screen device 302. In some embodiments, a data processing facility, such as local office 103 transmits the reward to a first screen device and/or second screen device.

In many of the embodiments described above, a determination is described as being made in response to a user setting or preference. One of skill in the art will recognize that in another aspect of the invention, any such setting or preference might be built into the system, or pre-determined by the manufacturer, seller, distributor, or another party other than the end user. Similarly, according to another aspect, any such setting might be available as a generic setting for the system or device as a whole, instead of customizable for individual users.

One or more aspects of the disclosure may be embodied in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

The descriptions above are merely example embodiments of various concepts. They may be rearranged/divided/combined as desired, and one or more components or steps may be added or removed without departing from the spirit of the present disclosure. The scope of this patent should only be determined by the claims that follow.

What is claimed is:

1. A method comprising:
transmitting primary content to a first device;
receiving an identification of a second screen event;
determining whether the second screen event is valid;
generating a reward in accordance with the second screen event;
assigning a unique identifier to the reward; and
transmitting the reward to a user.

2. The method of claim 1, further comprising:
requesting an identification of the second screen event.

3. The method of claim 1, further comprising:
determining user eligibility for receiving the reward; and
identifying a source application requesting the reward.

4. The method claim 1, further comprising:
identifying information content of the second screen event; and
using the information content of the second screen event to generate a plurality of rewards.

5. The method claim 4, wherein at least one reward of the plurality of rewards is customized in accordance with the information content of the second screen event.

6. The method claim 1, wherein a second device may present additional content in accordance with the information content of the second screen event.

7. The method claim 1, further comprising:
receiving a request for the presentation of the reward.

8. The method of claim 1, further comprising:
providing interactive content in accordance with the presentation of the reward.

9. The method claim 1, further comprising:
receiving an indication that the primary content was received.

10. A method comprising:
transmitting content to a first device;
determining whether a second screen event is valid, wherein the validity of the second screen event is determined in part by the amount of content consumed by a user;
acquiring information about the user, said information including demographic information of the user;
generating a plurality of rewards in accordance with the second screen event;
assigning a unique identifier to each reward in the plurality of rewards;
associating said unique identifier with user information in a database; and
selecting one or more rewards for transmission to the user.

11. The method of claim 10, further comprising:
storing user information received during the presentation of primary content on the first device.

12. The method of claim 10, further comprising:
transmitting one or more rewards to a second device.

13. The method of claim 10, further comprising:
presenting on the second device one or more rewards; and
providing interactive content in accordance with the presentation of the one or more rewards.

14. The method of claim 10, wherein at least one reward provides a user with enhanced viewing and listening capabilities.

15. A method comprising:
providing a server that is accessible via a computer network;
transmitting content to a device, wherein the transmitted content contains one or more embedded triggers for identifying a second screen event;
permitting the device to access said server via the computer network, wherein the device identifies a second screen event by comparing at least a first segment of the transmitted content with at least a first segment of content stored at said server;
determining whether the second screen event is valid; and
generating one or more rewards in accordance with the second screen event.

16. The method of claim 15, further comprising:
receiving a request to transmit additional content in accordance with information content of the second screen event.

17. The method of claim 15, further comprising:
transmitting one or more rewards to a first device associated with a user, wherein the transmitted reward is selected in part based on the user's prior content consumption.

18. The method of claim 15, wherein the device includes an input device configured to receive information transmitted from a first device associated with a user.

19. The method of claim 15, wherein the device is configured to transmit a request for the presentation of the reward.

20. The method of claim 15, wherein the device is configured to store user information during the transmission of content.
